(19) United States
(12) Patent Application Publication
(10) Pub. No.: US 2022/0080805 A1
(43) Pub. Date: Mar. 17, 2022

(54) Marine Product Logistics Monitoring Apparatus

(71) Applicants: Qiaowei Liu, Lianyungang (CN); Shiwei Liu, Lehi, UT (US); Xiaoge Cheng, Beijing (CN); Lishao Wang, Halifax (CA); Riming Hao, Beijing (CN); Lei Yang, Halifax (CA); Fred Lu, Halifax (CA); Zibo Wang, Zhuhai (CN)

(72) Inventors: Qiaowei Liu, Lianyungang (CN); Shiwei Liu, Lehi, UT (US); Xiaoge Cheng, Beijing (CN); Lishao Wang, Halifax (CA); Riming Hao, Beijing (CN); Lei Yang, Halifax (CA); Fred Lu, Halifax (CA); Zibo Wang, Zhuhai (CN)

(21) Appl. No.: 17/462,352

(22) Filed: Aug. 31, 2021

Related U.S. Application Data
(60) Provisional application No. 63/079,964, filed on Sep. 17, 2020.

(51) Int. Cl. B60H 1/00; G01S 19/01; G06Q 50/28; G05B 19/4155

(52) U.S. Cl. CPC B60H 1/00735; G01S 19/01; G05B 2219/37375; G06Q 50/28; G05B 19/4155; B60H 1/00978

(57) ABSTRACT

The present invention discloses an improved system of monitoring logistics involved in marine transportation. The proposed system with the help of data acquisition component, humidity control component, temperature control component, power component, microcontroller, and user device automatically regulate the required temperature and humidity level within preset threshold and also transmits the information to the user's device. This system also allows to add additional sensors and environmental control components including but not limited to ambient light, vibration, sound, movement, oxygen, chemical levels, and more. The system also provides a communication interface coupled to the onboard micro controller, where the communication interface being operative to transmit a monitoring update message to end user device, in response to a transmission instruction from the onboard microcontroller.

### BACKGROUND

### Field of the Invention

The present invention relates generally to computerized systems for expediting the shipping of goods in commerce. More particularly, the invention relates to a computerized logistics system for managing and integrating various aspects of order processing, order fulfillment and goods transportation and tracking in marine transportation services.

### Description of the Related Art

The shipment of packages and/or freight is an age-old method of transporting items from one location to another. Today, packages are shipped using a particular method (e.g., air, ground, rail, ocean, etc.) based on a desired and/or requested delivery date. For example, local domestic packages are shipped via ground using a truck. In some instances, a package is shipped using multiple methods of transportation between the originating and destination locations and are consolidated and deconsolidated several times at the various transportation mode interchange locations before reaching the final destination.

Multiple transitions between multiple links such as land transportation and air transportation are involved in a long-distance transportation process of marine products such as Cambarus and crabs from a source of supply to a supplier. Some uncertain factors such as the delay of a flight, weather conditions during the transitions, and whether careless loading and unloading are performed in this process would seriously affect the survival rates of marine products. Therefore, the external environment state and the internal environment where the marine products are located in the transportation process are monitored, and the transportation process can be reproduced by analyzing and processing data so that a logistics link that cannot be controlled by a supplier and a consignee becomes a link in which the process is clear and risks are controllable.

By looking at prior art there are multiple advancements that have been seen in logistics monitoring methods. For instance, a Chinese patent 1,057,61031A on logistics management system is issued to Tianjin City Kejian Electronic Mechanical Co Ltd. The patent provides a logistics management system. The logistics management system includes a transfer station, a carriage acceptance terminal, a monitoring device, a safety detection device and a scanning input device; the carriage acceptance terminal is equipped with a GPS; the monitoring device comprises a central processor and a memory, wherein the central processor is connected with the memory, and the central processor is connected with the safety detection device, the scanning input device, the transfer station and the GPS of the carriage acceptance terminal. With the logistics management system of the invention adopted, substantive safety inspection and whole-process tracking of logistic goods can be realized, and the safety of logistics can be improved.

Another U.S. Pat. No. 5,631,827A on Logistics system for automating transportation of goods is issued to United Parcel Service Deutschland Inc and Co oHG United Parcel Service of America Inc. The various transportation logistics tasks, such as order processing, order fulfillment, transportation of goods and tracking, are assigned to individual client/server objects which make up the building blocks of the computerized logistics management system. A tokenized message handling scheme allows client and server objects to share information, even where the respective data types do not match. An external processing manager provides script handling services to other client applications, allowing those applications to modify the performance of other program objects and to communicate with the outside world.

A Modem logistics monitoring system hearing Chinese patent 1,057,611324A is issued to Van Zi Zhu Electronic Science and Technology Co Ltd. The invention discloses a modern logistics monitoring system comprising a controller, an A/D conversion circuit and a carriage detection system; the carriage detection system comprises a. temperature sensor, a humidity sensor and a smoke concentration sensor, and the temperature sensor, the humidity sensor and the smoke concentration sensor are all connected with the controller by virtue of the A/D conversion circuit; the controller is also connected with an input module and an alarm driving module; the alarm driving module is connected with an alarm; the controller is connected with a wireless communication module; the wireless communication module is also connected with a driving recorder and a vehicle-mounted GPS module; the vehicle-mounted GPS module is mounted in a caB of a vehicle; the controller is also connected with a displayer. According to the modern logistics monitoring system provided by the invention, an internet of things technology is utilized to monitor the vehicle and simultaneously monitor goods in a carriage in real time, simple regulation can he carried out, and alarm information can he sent under severe conditions, so that monitoring people can do timely and correct commands, and the safety and the smoothness of running of a logistics vehicle are ensured.

Another Tracking and logistics management system and method bearing WO patent 2001075700A3 is issued to William R BoeschMark McgladeDavid J PulestonLars Skarke. The patent discusses a system for tracking containers for customer shipments using services from third party service providers, comprising a host management system. The host management system allows third party service providers and customers to enter in accounts containing information including preferences for shipping and/or services. The customer logs into the host management system through a network interface to enter in a shipment order. The host management system allows the customer to provide information concerning the shipment to ensure that the shipment can be performed and if any special services are needed from third party service providers. The customer can either choose their own third-party service providers or request quotes from third party service providers having a pre-established relationship with the host management system. The host management system receives tracking and other information concerning the shipment and automatically notifies the customer and third-party service providers providing services for the customer shipment of the shipment status so that any appropriate actions needed can be reported and/or taken.

Another U.S. Pat. No. 8,756,167B2 on Transmodal and logistics system and method are issued to EXPEDITORS MANAGEMENT SERVICES LLC. The patent relates to a transmodal and logistics method, comprising generating at least one transportation route for shipping a shipment using one or more different transportation modes and at least two transportation providers, and calculating a cost rate associated with the at least one transportation route.

A U.S. Pat. No. 8,150,781B2 on Package shipping system and method, including usage of historical analytic data is issued to Enroute Systems Corp. Embodiments provide methods, apparatus, systems, and computer-readable media associated with using historic analytic data, to identify shipping options for a user to use when shipping a package. Historic analytic data. may be received and maintained by a package shipment facilitation system. The analytics may then be used to generate business rules which may be applied to parameters for a package that is to be shipped. Through application of the business rules, one or more preferred shipping options may be identified. Business rules may be received after being manually-generated by a user, or may be automatically generated based at least in part on the maintained historic analytics. After a shipping option is chosen for the package, a shipping label may be printed for the package, and the package may be entered into a carrier's system for processing.

Another patent on Deter mining optimal routes and rates for cargo transportation bearing US patent 2,015,0248639A1 is issued to Synchro Net Logistics Inc. The patent provides a computer systems, methods, and non-transitory computer-readable medium configured for determining optimal routes and rates for cargos transportation between an origin location and a destination location, which determination takes into consideration available truck services from the origin to an origin rail ramp, rail services from the origin rail ramp to a destination rail ramp, and truck services from the destination rail ramp to the destination, along with location of empty containers as well as rates and incentives provided by each vendor.

Another US patent 1,101,7347B1 on Supply chain visibility platform is issued to Fourkites Inc. The patent provides systems, methods, and non-transitory media are provided for dynamically predicting visibility of freights in a constrained environment. An example method can include determining attributes associated with a load transported by a carrier from a source to a destination, the attributes including an identity of the carrier, an identity of an industry associated with the load, an identity of a shipper of the load, load characteristics, and/or a pickup time of the load; based on the attributes, predicting a route the carrier will follow when transporting the load to the destination, at least a portion of the route being predicted without data indicating an actual presence of the carrier within the portion of the route, the data including location measurements from a device associated with the carrier and/or a location update from the carrier; and generating a tracking interface identifying the route the carrier is predicted to follow.

Looking at prior art, transportation monitoring apparatuses currently adopted on the market only acquire and record information such as the temperature and the humidity inside a logistics box, but do not take external environment information as a reference, while the environment information directly affects the internal environment, especially for high-sensitivity objects requiring cold-chain logistics. Therefore, the apparatuses are not suitable for subsequent analysis and determination of the overall environment information in the transportation process. Thus, the optimization and risk assessment of a transportation route is affected.

There are multiple solutions that have been presented in prior art. However, these solutions are limited and restricted to their conventional architecture, installation system and have considerable shortcomings which adversely affect the convenience with which they can be used. The prior systems have certain limitations including the design of assemblies which make them not suitable for every type of user. Moreover, the ease-of-use ability of these assemblies is also questionable.

In order to solve the defects and deficiencies existing in the prior art, the utility model provides a marine product logistics monitoring apparatus, which controls the operation or shutdown of an evaporator or a humidifier by acquiring environment information inside and outside a logistics box for analysis and determination. The environment information can be tailored to the requirements of the specific embodiment through additional sensor modules and the tuning of the parameters, while additional environment control components may be added based on the requirements of the cargo. The apparatus will alert the user if any parameter falls outside a set threshold.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of marine product logistics monitoring system.

It is more particularly objective of invention to provide data acquisition component which is configured to acquire environment information inside and outside a logistics box and send the environment information to the microcontroller.

It is further the objective of the invention to provide a microcontroller which determines the acquired environment information according to set environment parameter thresholds, and then controls the on or off of the humidity control component and the temperature control component according to the determination results.

It is also the objective of the invention to provide a microcontroller which sends the environment information inside and outside the logistics box sent by the data acquisition component to the user device by means of a wireless module, and the environment information is displayed on the user device; and the power component is configured to supply power to the microcontroller.

A further object is to provide a data acquisition component which includes a temperature sensor I for acquiring temperature information inside the logistics box, a temperature sensor II for acquiring temperature information outside the logistics box, a humidity sensor for acquiring humidity information inside the logistics box, an acceleration sensor for acquiring acceleration amplitude information and frequency domain information of a transportation tool within a sampling duration.

A still further object is to provide a method where a camera is utilized for acquiring image information inside the logistics box; and the temperature sensor I, the temperature sensor II, the humidity sensor, the acceleration sensor, and the camera are respectively connected to the microcontroller.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a schematic diagram of the utility model, according to some example embodiments.

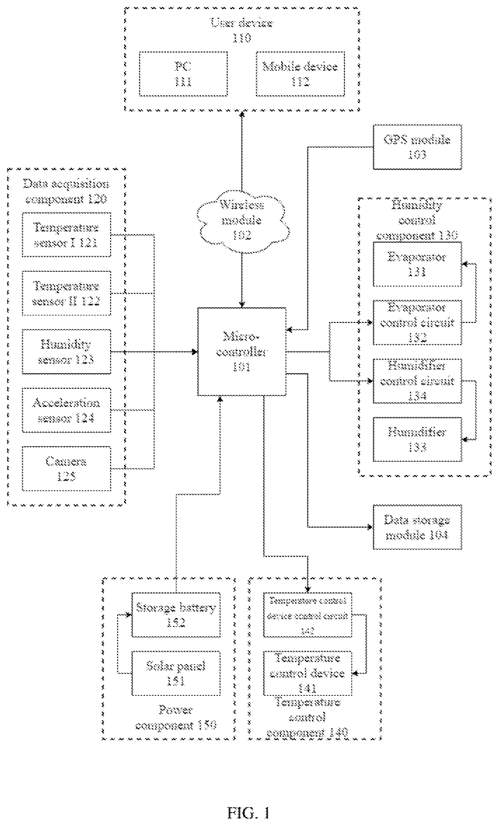

FIG. 2 is a logical flow chart of the utility model, according to one example embodiment.

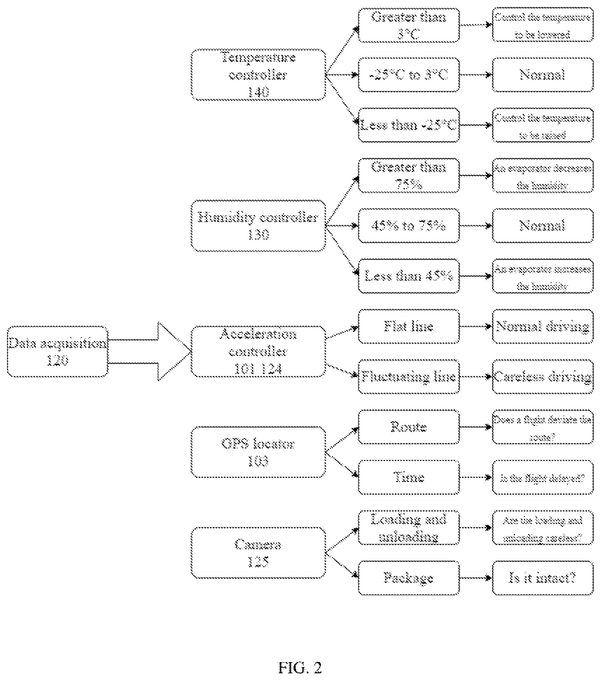

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof

The present invention relates to a marine product logistics monitoring apparatus, belonging to the field of Internet of Things technologies.

The utility model provides a marine product logistics monitoring apparatus, including: a data acquisition component 120, a humidity control component 130, a temperature control component 140, a power component 150, a microcontroller 101, and a user device 110. The data acquisition component is configured to acquire environment information inside and outside a logistics box and send the environment information to the microcontroller; the microcontroller determines the acquired environment information according to set environment parameter thresholds, and then controls the on or off of the humidity control component and the temperature control component according to the determination results; moreover, the microcontroller sends the environment information inside and outside the logistics box sent by the data acquisition component to the user device by means of a wireless module 103, and the environment information is displayed on the user device; and the power component is configured to supply power to the microcontroller.

The data acquisition component 120 includes a temperature sensor I 121 for acquiring temperature information inside the logistics box, a temperature sensor II 122 for acquiring temperature information outside the logistics box, a humidity sensor 123 for acquiring humidity information inside the logistics box, an acceleration sensor 124 for acquiring acceleration amplitude information and frequency domain information of a transportation tool within a sampling duration, and a camera 125 for acquiring image information inside the logistics box; and the temperature sensor I, the temperature sensor II, the humidity sensor, the acceleration sensor, and the camera are respectively connected to the microcontroller. Additional sensor modules may be added to the data acquisition component as required by the specific embodiment.

The humidity control component 130 includes an evaporator control circuit 132 and a humidifier control circuit 134 respectively connected to the microcontroller, and the microcontroller respectively controls the on or off of an evaporator 131 and a humidifier 133 by means of the evaporator control circuit and the humidifier control circuit. The temperature control component 140 includes a temperature control device control circuit 142 connected to the microcontroller, and the microcontroller controls the on or off of a temperature control device 141 by means of the temperature control device control circuit. Additional environmental control components may be added as required by the specific embodiment.

The wireless module 102 allows connection between the apparatus and the user device through several different connections, including both Bluetooth and through the internet.

The power component 150 includes a storage battery 152 and a solar panel 151.

The user device 110 is a PC 111 or a mobile device 112. The user device connects with the apparatus through the wireless module to update the microcontroller for the specific embodiment and set the parameters, as well as receiving real-time updates.

The monitoring apparatus further includes a GPS module 103 for locating the position of the transportation tool in real-time, and the GPS module is connected to the microcontroller.

The apparatus further includes a data storage module 104 connected to the microcontroller.

The beneficial technical effects achieved by the utility model are: the utility model provides a marine product logistics monitoring apparatus; in the apparatus, environment information inside and outside a logistics box is acquired by means of a data acquisition component and sent to a microcontroller; the microcontroller determines the received information according to pre-set environment parameters, and if the temperature is not within a set threshold range, the operation or shutdown of the temperature control device is controlled by means of a temperature control device control circuit; by the same reasoning, if the humidity is not within a threshold range, the operation or shutdown of an evaporator or a humidifier is controlled by means of a corresponding control circuit. Additional sensors and environmental control components can be added as required by the specific embodiment, including ambient light, vibration, sound, movement, oxygen, chemical levels, and more.

As a specific embodiment of the utility model, environment data in a transportation process is monitored by using the apparatus and used to adjust one or more environmental conditions described herein. The parameters are set by the user device through the wireless module. The temperature sensor I acquires the temperature information in the logistics box and sends the temperature information to the microcontroller, the microcontroller determines the received temperature information according to the pre-set temperature threshold, if the temperature exceeds the threshold range, refrigeration is performed in the logistics box by means of the temperature control device control circuit, and if the temperature is lower than the threshold range, heating is performed in the logistics box by means of the temperature control device control circuit till the temperature in the logistics box is within the threshold range; the temperature sensor II sends the acquired temperature information outside the logistics box to the microcontroller, and the microcontroller sends the temperature information to a memory for storage or sends the temperature information to the user device as a basis for subsequent optimization of a transportation route, so as to minimize the risks in the transportation process; the humidity sensor acquires the humidity information in the logistics box and sends the humidity information to the microcontroller, and the microcontroller controls the operation or shutdown of the evaporator by means of the evaporator control circuit or controls the on or off of the humidifier by means of the humidifier control circuit according to the pre-set humidity threshold; the acceleration sensor acquires speed information of the transportation tool and sends the speed information sends the microcontroller, and the camera acquires picture information in the logistics box and sends the picture information to the microcontroller; in addition, the GPS module acquires real-time position information of the transportation tool and sends the real-time position information to the microcontroller. The microcontroller retains all recorded data through a data storage module and updates the user device through the wireless module. Additional tweaks to the parameters can be set by the user device, such as automatic adjustment based on GPS location.

Further description is made by taking the transportation of fish and shrimp as an example. The temperature threshold in the logistic box is pre-set to be −20° C. to 5° C., the temperature sensor 1 sends the acquired temperature information in the logistic box to the microcontroller, the microcontroller determines the received temperature information, if the temperature exceeds the threshold range, refrigeration is performed in the logistics box by means of the temperature control device control circuit, and if the temperature is lower than the threshold range, heating is performed in the logistics box by means of the temperature control device control circuit till the temperature in the logistics box is within the threshold range; the temperature sensor 2 acquires a weather environment parameter outside the logistic box, and sends the acquired data to the microcontroller, the microcontroller sends the acquired data to the memory for storage or sends the acquired data to the user device, and a transportation party can obtain optimal matched values of the temperature outside the logistics box and the temperature inside the logistics box by matching according to the stored data so as to ensure the freshness of the fish and shrimp. Data support is provided for the subsequent setting of the temperature in the logistics box, so as to minimize the risks in the transportation process; the humidity threshold in the transportation process of the fish and shrimp is set to be 45% to 70%, the humidity sensor sends the acquired humidity information in the logistics box to the microcontroller, and the microcontroller controls the operation or shutdown of the evaporator by means of the evaporator control circuit or controls the on or off of the humidifier by means of the humidifier control circuit according to the pre-set humidity threshold; in addition, in the transportation process, the acceleration sensor acquires the speed information of the transportation tool and sends the speed information to the microcontroller; if a curve displayed in the microcontroller is in a flat state, it is indicated that the transportation process is relatively smooth, and if a sudden increase in height occurs in the displayed curve, it is indicated that cases such as bumpy or careless transportation occur in the transportation process; the camera acquires the picture information in the logistics box and sends the picture information to the microcontroller; in addition, the GPS locator acquires the real-time position information of the transportation tool and sends the real-time position information to the microcontroller, and whether a flight is delayed or on time can be determined by combining locating information of the GPS and the normal schedule of the flight.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A marine product logistics monitoring apparatus, comprising: a data acquisition component, a humidity control component, a temperature control component, a power component, a microcontroller, and a user device, wherein the data acquisition component is configured to acquire environment information inside and outside a logistics box and send the environment information to the microcontroller; the microcontroller determines the acquired environment information according to set environment parameter thresholds, and then controls the on or off of the humidity control component and the temperature control component according to the determination results; moreover, the microcontroller sends the environment information inside and outside the logistics box sent by the data acquisition component to the user device by means of a wireless module, and the environment information is displayed on the user device;
and the power component is configured to supply power to the microcontroller where:

2. The marine product logistics monitoring apparatus according to claim 1, wherein the data acquisition component comprises a temperature sensor I for acquiring temperature information inside the logistics box, a temperature sensor II for acquiring temperature information outside the logistics box, a humidity sensor for acquiring humidity information inside the logistics box, an acceleration sensor for acquiring acceleration amplitude information and frequency domain information of a transportation tool within a sampling duration, and a camera for acquiring image information inside the logistics box; and the temperature sensor I, the temperature sensor II, the humidity sensor, the acceleration sensor, and the camera are respectively connected to the microcontroller.

3. The marine product logistics monitoring apparatus according to claim 1, wherein the humidity control component comprises an evaporator control circuit and a humidifier control circuit respectively connected to the microcontroller, and the microcontroller respectively controls the on or off of an evaporator and a humidifier by means of the evaporator control circuit and the humidifier control circuit.

4. The marine product logistics monitoring apparatus according to claim 1, wherein the temperature control component comprises a temperature control device control circuit connected to the microcontroller, and the microcontroller controls the on or off of a temperature control device by means of the temperature control device control circuit.

5. The marine product logistics monitoring apparatus according to claim 1, wherein the power component comprises a storage battery and a solar panel.

6. The marine product logistics monitoring apparatus according to claim 1, wherein the user device is a PC or mobile device.

7. The marine product logistics monitoring apparatus according to claim 1, wherein the monitoring apparatus further comprises a GPS module for locating the position of the transportation tool in real-time, and the GPS module is connected to the microcontroller.

8. The marine product logistics monitoring apparatus according to claim 1, wherein the apparatus further comprises a data storage module for storing data, and the data storage module is connected to the microcontroller.

9. A marine logistics monitoring apparatus facilitating:

10. A marine logistics monitoring apparatus as per claim 9, providing environment information inside and outside a logistics box;

11. A marine logistics monitoring apparatus as per claim 9, providing a data acquisition component which is sent to a microcontroller;

12. A marine logistics monitoring apparatus as per claim 9, where the microcontroller determines the received information according to pre-set environment parameters;

13. A marine logistics monitoring apparatus as per claim 9, where if the temperature is not within a set threshold range, the operation or shutdown of the temperature control device is controlled by means of a temperature control device control circuit;

14. A marine logistics monitoring apparatus as per claim 9, where if the humidity is not within a threshold range, the operation or shutdown of an evaporator or a humidifier is controlled by means of a corresponding control circuit;

15. A marine logistics monitoring apparatus as per claim 9, where additional sensors and environmental control components can be added as required by the specific embodiment, including ambient light, vibration, sound, movement, oxygen, chemical levels, and more.
